(19) United States
(12) Patent Application Publication
(10) Pub. No.: US 2025/0157804 A1
(43) Pub. Date: May 15, 2025

(54) MASS SPECTROMETER

(71) Applicant: SHIMADZU CORPORATION, Kyoto-shi (JP)

(72) Inventor: Yusuke SAKAGOSHI, Kyoto-shi (JP)

(21) Appl. No.: 18/838,620

(22) PCT Filed: Feb. 15, 2022
(86) PCT No.: PCT/JP2022/005977

§ 371 Date: Aug. 15, 2024

(51) Int. Cl. H01J 49/00; H01J 49/06; H01J 49/42

(52) U.S. Cl. CPC H01J 49/0022; H01J 49/063; H01J 49/4215

(57) ABSTRACT

An object of the present invention is to provide a mass spectrometer capable of easily attaching and detaching electrical wiring of an ion optical element even when another system unit or the like is placed on an upper part of the mass spectrometer.

A mass spectrometer comprises: a chamber VC forming a vacuum chamber; an ion optical element MFP arranged in the chamber; and a power supply line for supplying power to the ion optical element from a power source arranged outside the chamber. An opening OP is formed in at least a portion of wall surfaces of the chamber, excluding upper and lower surfaces and a side lid VC1 is provided to cover the opening. A connecting position between the power supply line FT and a cable CA and a connecting position between the ion optical element (terminal MT) and the cable CA are set at positions that allow the cable CA to be removed from the opening with the ion optical element housed in the chamber.

### TECHNICAL FIELD

The present invention relates to a mass spectrometer, and more particularly to a mass spectrometer in which ion optical elements such as a quadrupole mass filter and a collision cell are arranged in a chamber forming a vacuum chamber.

### RELATED ART

A mass spectrometer is configured to generate ions from compounds contained in a sample in an ion source, separate the various ions according to their mass-to-charge ratio (m/z) using a quadrupole mass filter or the like, and detect the separated ions with an ion detector. The sample introduced into the mass spectrometer is a sample derived from a liquid chromatograph or a gas chromatograph. Further, in order to separate ions, not only a quadrupole mass filter but also a configuration in which quadrupole mass filters are arranged in front and behind a collision cell can be used.

During analysis in the mass spectrometer, neutral particles and ions derived from the sample adhere to ion optical elements such as rod electrodes that make up the quadrupole mass filter and the rod electrodes arranged in the collision cell. Contamination of the ion optical elements causes disturbances in an electric field formed by the ion optical elements, resulting in a decrease in measurement accuracy such as detection sensitivity and mass resolution. This requires maintenance work such as removing the quadrupole mass filter unit and collision cell from the equipment and cleaning them. In normal maintenance work, an openable lid is provided on a top of a vacuum chamber, and with this lid open, the quadrupole mass filter and the collision cell can be removed from above or installed from above.

FIG. 1 shows an example of a liquid chromatography mass spectrometry (LC-MS) system that uses a mass spectrometer as a detector for a liquid chromatograph (LC). In addition to the mass spectrometer 1, the system is composed of several units such as liquid delivery units 3 and 4, which include a pump that delivers a mobile phase, an injection unit 5 that injects a sample into the delivered mobile phase, and a column oven unit 2 that houses a column. In recent years, there has been a strong demand for reducing an installation space of systems, and miniaturized mass spectrometers have been developed. For this reason, as shown in FIG. 1, some units of the liquid chromatograph are placed on top of the mass spectrometer 1, or other mass spectrometers are stacked on top of it.

When other units or the like are placed on the mass spectrometer 1 as shown in FIG. 1, it is necessary to move the other units or the like placed on the mass spectrometer 1 to open and close the top lid of the vacuum chamber in the mass spectrometer. This makes the maintenance work on ion optical elements or the like complicated and time-consuming. To solve this problem, Patent Document 1 proposes providing an opening on one of the sides on either side of the ion optical axis and a side lid to cover the opening.

In Patent Document 1, as shown in FIGS. 2 and 3, an opening OP is formed in a side of a vacuum chamber VC, and a side lid VC1 (only the outline is shown in dotted lines) is provided to cover the opening. In FIG. 2, a quadrupole mass filter MF and an ion detector ID can be seen from the opening. An ion gauge IM for measuring a degree of vacuum in the vacuum chamber is installed on a right end surface of the vacuum chamber VC. Further, in FIG. 3, the front quadrupole mass filter MF1, a collision cell CC, the rear quadrupole mass filter MF2 and the ion detector ID can be seen from the opening OP.

In Patent Document 1, in order to easily remove and attach ion optical elements such as the quadrupole mass filter and the collision cell from the opening OP, a mechanism is provided that allows the ion optical elements to be easily attached and detached to or from a pedestal that secures them. Specifically, as shown in FIG. 4, when a rod holder RH that holds four rod electrodes MFP that make up the quadrupole mass filter is fixed to the pedestal PD, one end of a fixing band BA is engaged with a recess HL formed in a side wall S1 (left side of the drawing) of the vacuum chamber, and the other end of the fixing band is fixed to the pedestal PD with a screw SC.

Conventionally, when fixing the quadrupole mass filter to the pedestal, both ends of the fixing band were screwed to the pedestal. In contrast, with the configuration shown in FIG. 4, the fixing band can be easily released by simply removing the screw SC from the opening OP, reducing the effort required to remove and install the quadrupole mass filter MF.

Further, in the case of the collision cell CC, as shown in FIG. 3, the cell body (CC) that holds the rod electrodes can be fixed to a pedestal PD2 using a fixing band BA2 or the screw SC which has a configuration similar to that of the quadrupole mass filter, making it possible to easily attach and detach the cell to or from the opening OP.

On the other hand, electrical wiring is connected to many of the ion optical elements, and when attaching or detaching the ion optical elements to or from the main body of the device, this wiring must also be removed or installed. As shown in FIG. 4, a circuit unit and a vacuum pump unit are arranged in one of the units denoted by symbol 20, 30 or 40 around the vacuum chamber VC. In particular, a power supply that supplies voltage to the rod electrodes of the quadrupole mass filter is often placed at the position of the circuit unit 30 for ease of assembly and maintenance but is not limited to this and may be placed in the unit denoted by symbol 20 or 40. For this reason, a feedthrough portion that penetrates the wall of the vacuum chamber VC is formed for wiring from the power supply unit into the vacuum chamber VC. This “feedthrough portion” includes hermetic connectors, vacuum connectors or the like and refers to a connector (power supply line) that penetrates the wall of the vacuum chamber.

When removing the ion optical element, it is necessary to first remove the wiring connected to the ion optical element from the feed-through portion. For example, as shown in FIG. 4, in the case where the feed-through portion is located on a wall surface S1 behind the ion optical element such as the quadrupole mass filter or the collision cell, the ion optical element gets in the way and the wiring cable connected to the feed-through portion cannot be easily removed. For this reason, conventionally, various devices arranged above the mass spectrometer were removed and the wiring cables were removed by reaching in through the opening in a top surface of the vacuum chamber VC. This made maintenance work for the ion optical element more complicated and meant that the opening on the sides of the vacuum chamber VC as in Patent Document 1 could not be fully utilized.

### PRIOR ART DOCUMENT

### Patent Document

Patent Document 1: JP-A 2021-82496

### SUMMARY OF THE INVENTION

### Problem to be Solved by the Invention

The present invention has been made to solve the above-mentioned problems, and an object of the present invention is to provide a mass spectrometer that allows easy attachment and detachment of electrical wiring of ion optical elements such as a quadrupole mass filter even when other system units such as a liquid chromatograph or a gas chromatograph are installed on a top of the mass spectrometer.

### Means for Solving the Problem

One aspect of a mass spectrometer according to the present invention, which has been made to solve the above problems, is as follows.

A mass spectrometer comprises: a chamber forming a vacuum chamber; an ion optical element arranged along an ion optical axis in the chamber; a power supply line for supplying power to the ion optical element from a power source arranged outside the chamber; and a cable connecting the power supply line and the ion optical element, wherein an opening is formed in at least a portion of wall surfaces of the chamber, excluding upper and lower surfaces, through which the ion optical element can be inserted and removed in and from the chamber and a side lid is provided to cover the opening, and wherein a connecting position between the power supply line and the cable and a connecting position between the ion optical element and the cable are set at positions that allow the cable to be removed from the opening with the ion optical element housed in the chamber.

### Effects of the Invention

According to the above aspect of the mass spectrometer of the present invention, the connecting position of the power supply line and the cable and the connecting position of the ion optical element and the cable are set at positions that allow the cables to be removed from the opening provided in the vacuum chamber with the ion optical element housed in the chamber. This makes it easy to attach and detach the electrical wiring (cable) connected to the ion optical element. In particular, there is no need to attach and detach the cable from an opening on the top side of the vacuum chamber, making it possible to easily perform maintenance work.

### BRIEF DESCRIPTION OF THE DRAWINGS

FIG. 1 is a perspective view of an exterior of a liquid chromatography mass spectrometry (LC-MS) system using a mass spectrometer.

FIG. 2 is a schematic plan view showing an example of a mass spectrometer disclosed in Patent Document 1.

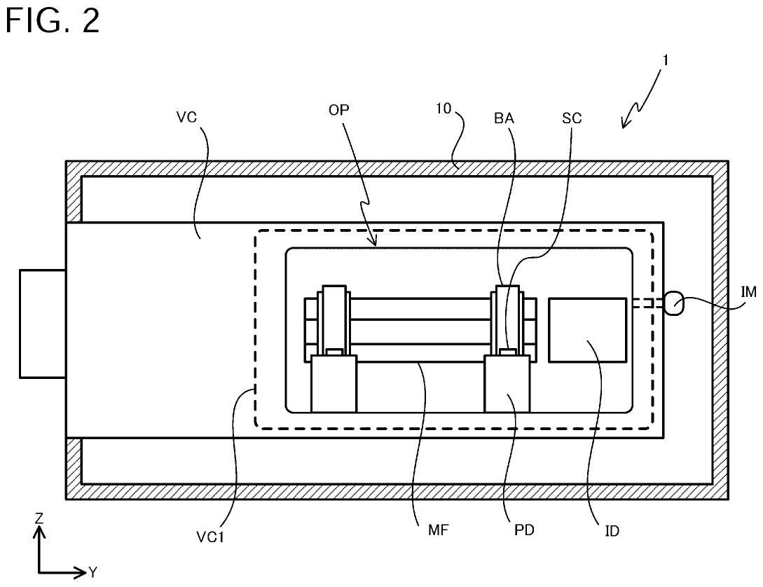

FIG. 3 is a schematic plan view showing another example of the mass spectrometer (including a collision cell) disclosed in Patent Document 1.

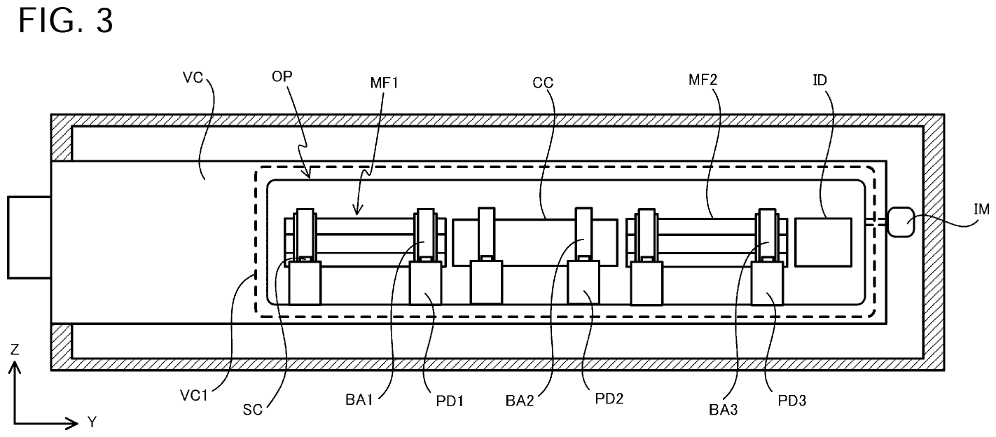

FIG. 4 is a schematic vertical cross-sectional view of the mass spectrometer disclosed in Patent Document 1.

FIG. 5 is a schematic view showing an example of an internal structure of a mass spectrometer.

FIG. 6 is a schematic vertical cross-sectional view showing an example of the mass spectrometer of the present invention.

FIG. 7 is a schematic vertical cross-sectional view showing another embodiment of the mass spectrometer of the present invention.

FIG. 8 is a perspective view showing a wiring of a first cable connecting a feed-through portion to a relay member in the mass spectrometer of the present invention.

FIG. 9 is a schematic view showing a wiring of a second cable connecting a relay member to a quadrupole mass filter in the mass spectrometer of the present invention.

### MODE FOR CARRYING OUT THE INVENTION

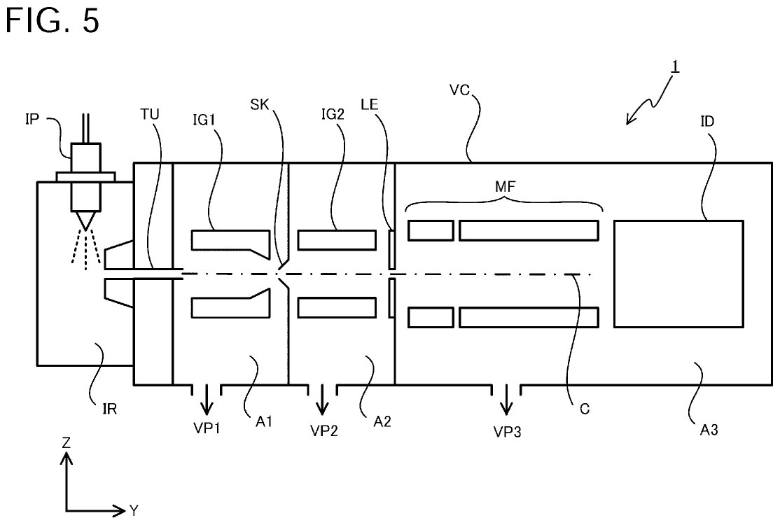

A mass spectrometer of the present invention will be described in detail with reference to FIGS. 5 to 9.

FIG. 5 is a diagram showing a configuration of main parts of a mass spectrometer 1, which is an example of the mass spectrometer to which the present invention can be applied. An interior of a vacuum chamber VC is partitioned into three chambers: a first intermediate vacuum chamber A1, a second intermediate vacuum chamber A2, and a high vacuum chamber A3. An ionization unit that defines an ionization chamber IR inside is attached to a front of the vacuum chamber VC. The first intermediate vacuum chamber A1, the second intermediate vacuum chamber A2 and the high vacuum chamber A3 are each evacuated (see arrows VP1-VP3) by a vacuum pump (not shown), and the ionization chamber IR is connected to an outside.

An ionization probe IP is provided in the ionization chamber IR, and the ionization chamber IR and the first intermediate vacuum chamber A1 are connected through a solvent removing tube TU having a thin-diameter. A first ion guide IG1 is disposed inside the first intermediate vacuum chamber A1, and the first intermediate vacuum chamber A1 and the second intermediate vacuum chamber A2 are connected through a small hole formed in a top of a skimmer SK. A second ion guide IG2 is disposed inside the second intermediate vacuum chamber A2, and the second intermediate vacuum chamber A2 and the high vacuum chamber A3 are connected through a small hole formed in a center of a lens electrode LE. A quadrupole mass filter MF including a pre-rod electrode and a main rod electrode and an ion detector ID are disposed inside the high vacuum chamber A3.

As shown in FIG. 5, the solvent removing tube TU, the first ion guide IG1, the skimmer SK, the second ion guide IG2, the lens electrode LE, the quadrupole mass filter MF and the ion detector ID are arranged approximately in a straight line along an ion optical axis C.

In the present invention, “ion optical element” includes, for example, a quadrupole mass filter, an ion guide, an ion lens, an ion trap, a deflector and a reflector that control behavior of ions by an action of an electric field. It also includes a collision cell that provide a space for dissociating ions. In particular, the present invention can be applied to ion optical elements that are placed in a vacuum chamber and operate by receiving power via a feed-through portion.

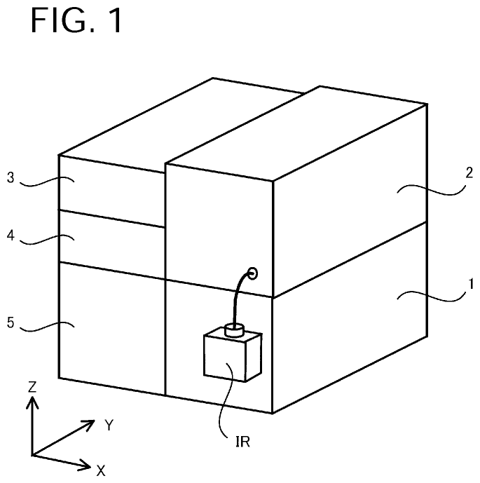

The mass spectrometer 1 in FIG. 5 is incorporated into the liquid chromatography mass spectrometry (LC-MS) system shown in FIG. 1. The analysis operation in the LC-MS system will be briefly described.

The liquid delivery units 3 and 4 in FIG. 1 feed a single or mixed two-liquid mobile phase to a column at a predetermined flow rate (flow rate). Injection unit 5 selects one of a plurality of samples prepared in advance, aspirates it and injects it into the mobile phase being delivered to the column at a predetermined timing. In the column oven unit 2, the column is maintained at, for example, a substantially constant temperature. When a sample is introduced into the column by being pushed by the flow of the mobile phase, the various components (compounds) contained in the sample are separated over time as they pass through the column. Then, an eluate containing the separated components is discharged from an outlet of the column and introduced into the ionization probe 15 of the mass spectrometer 1.

The ionization probe IP sprays the eluate into the ionization chamber IR, which is at approximately atmospheric pressure, and ionizes the sample components contained in the eluate. The ionization method can be, for example, electrospray ionization or atmospheric pressure chemical ionization. The generated ions are sent through the solvent removing tube TU into the first intermediate vacuum chamber A1, and then through the first ion guide IG1, skimmer SK, second ion guide IG2 and lens electrode LE to the high vacuum chamber A3. Ions derived from the sample components are introduced into the quadrupole mass filter MF, and only ions having a specific mass-to-charge ratio corresponding to the voltage applied to the rod electrodes that make up the quadrupole mass filter MF pass through the quadrupole mass filter MF, and other ions diverge along the way. The ion detector ID detects the ions that have passed through the quadrupole mass filter MF and outputs a detection signal according to the amount of ions.

In this way, in this LC-MS system, multiple components contained in a sample can be separated on the time axis, and detection signals corresponding to the amount (concentration) of each component can be obtained by the mass spectrometer 1. As described above, inside the vacuum chamber VC of the mass spectrometer 1, ions derived from the sample components travel along the ion optical axis C (Y-axis direction). The above describes the combination of the liquid chromatograph and the mass spectrometer, but the present invention can also be used in combination with a gas chromatograph and the mass spectrometer.

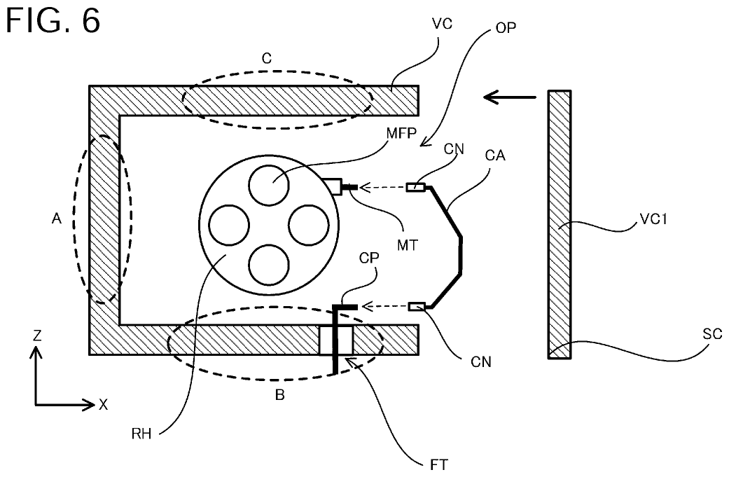

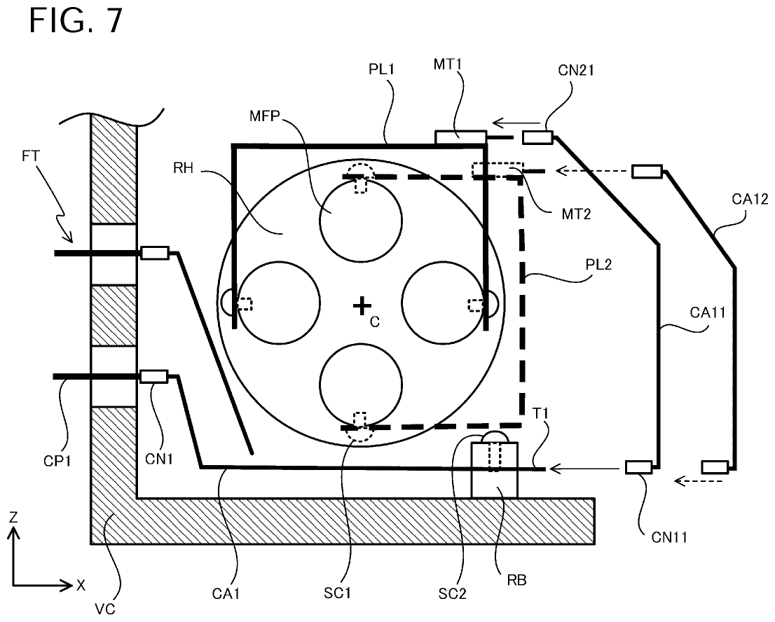

FIGS. 6 and 7 are schematic vertical cross-sectional views showing an embodiment of the mass spectrometer of the present invention.

In the mass spectrometer of the present invention, the ion optical elements are arranged along the ion optical axis (see symbol C in FIG. 5) in the chamber VC that forms the vacuum chamber. FIGS. 6 and 7 show a quadrupole mass filter as an example of an ion optical element. In the quadrupole mass filter, four rod electrodes MFP are held by a rod holder RH.

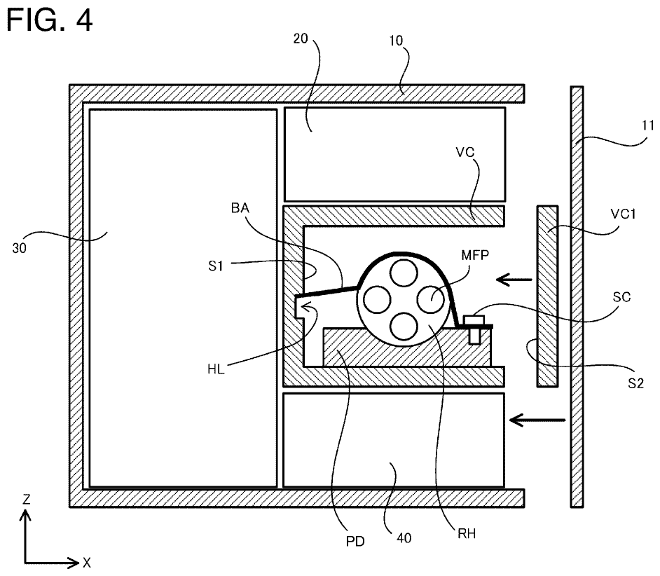

In the embodiment of FIG. 6, an opening OP is formed in a side wall of the vacuum chamber VC, and a side lid VC1 is provided to cover the opening OP. A power supply (not shown) arranged outside the vacuum chamber VC and the ion optical element (quadrupole mass filter) arranged inside the vacuum chamber VC are connected by a power supply line. The power supply is placed at the position of the unit denoted by the symbol 20, 30 or 40 in FIG. 4. If the power supply line from the power supply is long, a capacitance component becomes large, which is undesirable for supplying high frequency voltage. For this reason, depending on the placement of the power supply, a feed-through portion is formed in each of the dotted areas A to C in FIG. 6, excluding the wall surface where the opening OP is formed. In FIG. 6, as an example, the power supply line (feed-through portion) FT is formed in area B (the bottom surface of the vacuum chamber).

The feed-through portion FT and a terminal MT provided on the ion optical element are electrically connected using a cable CA. As shown in FIG. 6, connectors CN are provided on both ends of the cable CA, and each connector is joined to the end of the feed-through portion FT or the terminal MT for electrical wiring.

In the present invention, the connection positions between the power supply line and the cable and the connection positions between the ion optical element and the cable are set at positions that are easily accessible by an operator from the opening OP and allow the cable to be removed, even when the ion optical element is housed in the vacuum chamber VC. In FIG. 6, when the side lid VC1 is removed, the connection between the feed-through portion FT and the connector CN and the connection between the terminal MT and the connector CN are exposed on a side of the opening. This allows the operator to easily disconnect each connection.

However, when the ion optical element is placed in the vacuum chamber VC, placing the feed-through portion FT at the back of area A, area B or area C makes it difficult for the operator to access. In order to solve such a problem, in the present invention, as shown in FIG. 7, it is also possible to use a separate cable for the power supply line, which connects the connector (feed-through portion) that penetrates the wall of the vacuum chamber to a relay member that is placed inside the vacuum chamber.

As shown in FIG. 7, a wall surface S1 is provided with a feed-through portion FT for supplying power to the ion optical element such as the quadrupole mass filter, and a connector pin CP1 penetrates the side wall. The connector pin CP1 is surrounded by an insulating member and is electrically insulated from the side wall that forms the vacuum chamber.

A relay member RB for the cable is placed on the bottom surface of the vacuum chamber VC. The relay member RB is fixed so that it does not move inside the chamber in order to attach and detach a connector of a second cable as described below.

A first cable CA1 is connected from the connector pin CP1 of the feed-through portion to the relay member RB. A connector CN1 is provided at one end of the first cable CA1, and the connector pin CP1 is configured to be inserted into the connector CN1. The electrical and mechanical connection method is not limited to the shapes of the pin and connector, and any connection method known to those skilled in the art can be used.

The first cable CA1 and the relay member RB can also be connected by previously providing metal fittings such as pins or connectors on the relay member in advance and connecting metal fittings provided at the end of the cable to them. Here, in order to ensure a reliable electrical connection, a hole is drilled in the main body of the relay member, which is made of an insulating material, through which the tip of the first cable passes, and with the first cable passing through the hole, the first cable is fixed to the relay member with fixing means SC2 such as a screw.

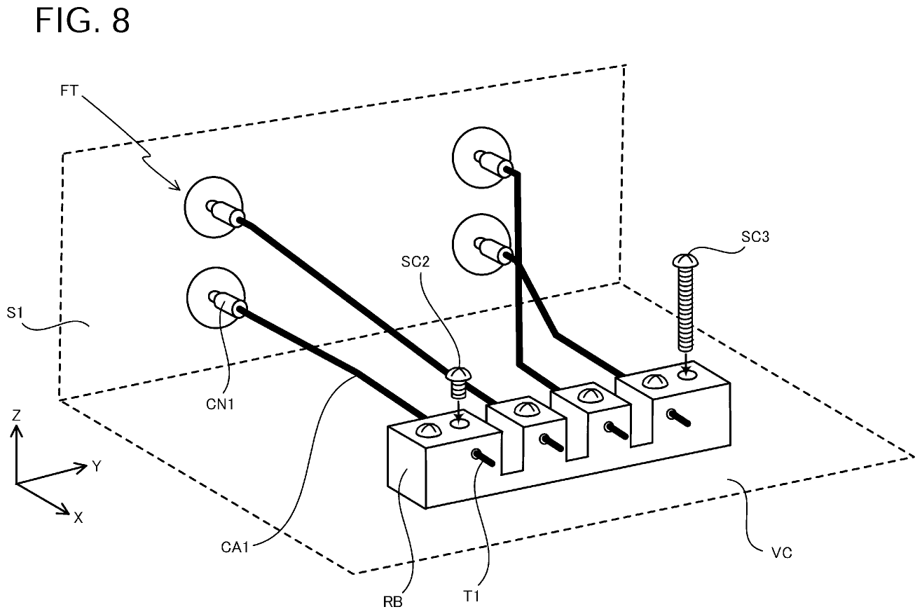

FIG. 8 is a perspective view showing a wiring state of the first cable from the feed-through portion FT to the relay member RB. The relay member RB itself is fixed to the vacuum chamber VC by another screw SC3 or the like.

Next, the second cable (CA11, CA12) connects the relay member RB to the quadrupole mass filter (rod electrode MFP) as shown in FIG. 7. A connector CN11 is provided at one end of the second cable, which is connected to a tip T1 of the first cable fixed to the relay member RB. The connector at the other end of the second cable is connected to the electrode terminal of the quadrupole mass filter.

In the quadrupole mass filter, the same voltage is applied to the opposing rod electrodes, so plates (PL1, PL2) are provided to electrically connect the opposing electrodes. The connector CN21 of the second cable is connected to terminals (MT1, MT2) formed on these plates.

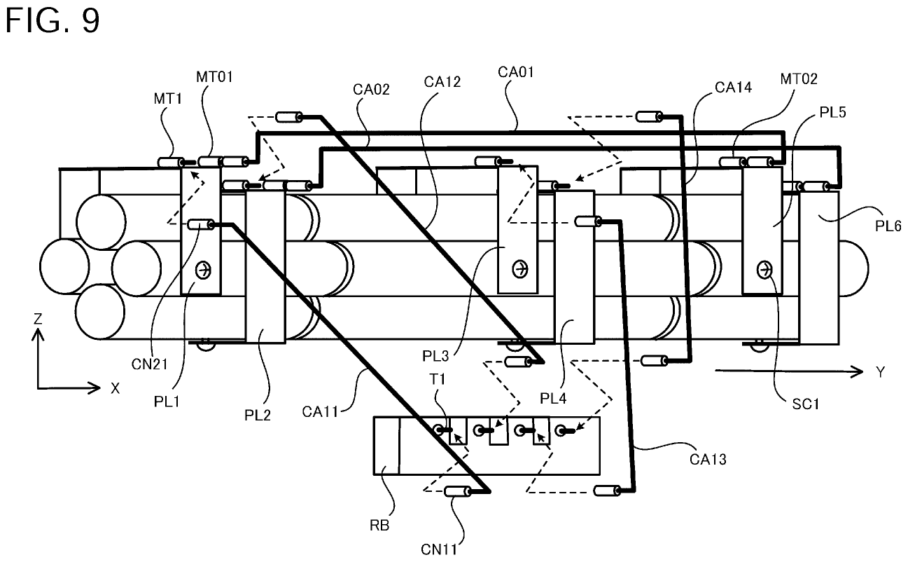

FIG. 9 shows an example of the quadrupole mass filter using one rod electrode with three electrode sections in an ion optical axis direction. The one rod electrode has the three metal electrodes connected in series with an insulator between them. In FIG. 9, in the one rod electrode, wiring cables (CA01, CA02) are used to connect the electrodes at both ends because the same voltage is applied to both electrodes. The connectors at the ends of each cable are connected, for example, to terminal MT01 of plate PL1 and terminal MT02 of plate PL5. The same is true for plate PL2 and plate PL6.

The second cable CA11 from the relay member RB is connected to a terminal MT1 provided on the plate PL1. Similarly, second cables (CA12, CA13, CA14) are connected between the relay member RB and the plates (PL2, PL3, PL4) of each rod electrode.

By using such a relay member, the electrical connection of the quadrupole mass filter can be easily released by simply disconnecting the second cable (CA11, CA12 or the like) shown in FIG. 7 or FIG. 9. In addition, the second cable can be easily attached and detached through the opening provided on the side of the vacuum chamber, allowing maintenance work to be performed efficiently.

In order to improve accessibility from the opening on the side of the vacuum chamber, as shown in FIG. 7, the relay member RB is placed between the position where the ion optical element such as the quadrupole mass filter is located and the opening.

Further, as described above, the connector that allows the second cable to be detached is used to connect the ion optical element such as the quadrupole mass filter or the relay member RB to the second cable. This makes it easier to disconnect or connect the electrical connection.

In FIGS. 7 and 9, the terminal to which the connector of the second cable is connected faces the opening, making it easy to attach and detach the connector. For example, the cables (CA01, CA02) in FIG. 9, which are unrelated to the connection of the second cable, do not need to be removed when removing the quadrupole mass filter. For such parts that do not require detachment, the terminals (MT01, MT02) on the plate can be configured to face upward or downward or opposite the opening, so that they are not removed together with the second cable.

In the above description, only the first cable is arranged between the feed-through portion and the relay member, but it is also possible to configure a part or all of the first cable by dividing the first cable into two or more parts and connecting them via another relay member. Further, the second cable can also be configured so that another relay member is placed on part of the member that makes up the ion optical element, and the second cable is relayed through it. In this case, the same effect as the above configuration can be obtained by attaching and detaching the cable (part of the second cable) that connects between the relay member placed in the vacuum chamber and the relay member placed in the ion optical element.

Further, by combining and applying the configuration of the present invention with the configuration of a fixing band or the like as disclosed in Patent Document 1, it becomes possible to more efficiently remove and install the ion optical element.

The above description of the mass spectrometer of the present invention is one example of an embodiment, and it is clear that appropriate modifications, additions, and amendments within the spirit and scope of the present invention still fall within the technical scope of the present invention.

It will be appreciated by those skilled in the art that the exemplary embodiments described above are examples of the following aspects.

[1]A mass spectrometer comprises:
a chamber forming a vacuum chamber;
an ion optical element arranged along an ion optical axis in the chamber;
a power supply line for supplying power to the ion optical element from a power source arranged outside the chamber; and
a cable connecting the power supply line and the ion optical element,
wherein an opening is formed in at least a portion of wall surfaces of the chamber, excluding upper and lower surfaces, through which the ion optical element can be inserted and removed in and from the chamber and a side lid is provided to cover the opening, and
wherein a connecting position between the power supply line and the cable and a connecting position between the ion optical element and the cable are set at positions that allow the cable to be removed from the opening with the ion optical element housed in the chamber.

With this configuration, the electrical and mechanical connections of the ion optical elements can be easily disconnected simply by attaching and detaching the cables accessible from the opening. This makes it easy to perform work through the opening provided on the side of the vacuum chamber.

[2] In the mass spectrometer described in the above item [1], the power supply line has a separate cable connecting a connector penetrating the wall surface of the chamber and a relay member disposed within the chamber.

By using the relay member, even if the power supply line connector (feed-through portion) is located in a place that is difficult to access from the opening, by placing the relay member in an easily accessible location, it becomes possible to easily perform work such as disconnecting the electrical connection from the opening.

[3] In the mass spectrometer described in the above item [2], the relay member is disposed between the ion optical element and the opening.

This configuration improves accessibility from the opening provided on the side of the vacuum chamber to the relay member, particularly to the connector of the cable connected to the relay member (the cable connected to the ion optical element).

[4] In the mass spectrometer described in the above item [1], the cable is connected to the ion optical element and the power supply line by a detachable connector.

This configuration allows the cables to be attached and detached more smoothly to and from the ion optical element and the relay member.

[5] In the mass spectrometer described in the above item [1], the power supply is disposed adjacent to the chamber outside the chamber, except for a surface side in which the opening is formed.

By adopting the above-described configuration of the present invention, it becomes possible to easily attach and detach the cable through the opening regardless of the position of the power source.

[6] In the mass spectrometer described in the above item [1], a portion where the power supply line penetrates the wall surface of the chamber is formed at a position other than a surface side where the opening is formed.

By adopting the above-described configuration of the present invention, it becomes possible to easily attach and detach the cable from the opening regardless of the position of the portion (feed-through portion) where the power supply line penetrates the wall surface of the chamber.

[7] In the mass spectrometer described in the above item [1] or [2], the ion optical element is a quadrupole mass filter.

This configuration makes it easy to remove and install the quadrupole master filter, which is easily soiled in the mass spectrometer and can affect analytical performance, from the main body of the mass spectrometer in order to clean it.

[8] In the mass spectrometer described in the above item [1] or [2], the mass spectrometer is a mass spectrometer that analyzes a sample supplied from a liquid chromatograph or a gas chromatograph.

With this configuration, even when the mass spectrometer is used in combination with the liquid chromatograph or the gas chromatograph, the quadrupole mass filter and other ion optical elements can be easily cleaned and otherwise maintained, making it possible to maintain high analytical performance.

### REFERENCE SIGNS LIST

1: Mass spectrometer
2: Column oven unit
3, 4: Liquid delivery unit
5: Injection unit
VC: Vacuum chamber
VC1: Side lid
A1: First intermediate vacuum chamber
A2: Second intermediate vacuum chamber
A3: High vacuum chamber
IR: Ionization chamber
IP: Ionization probe
TU: Solvent removing tube
IG1: First ion guide
SK: Skimmer
IG2: Second ion guide
LE: Lens electrode
MF: Quadrupole mass filter
MFP: Rod electrode
RH: Rod holder
BA, BA1-3: Fixing band
SC, SC1-3: Screw
ID: Ion detector
10: Exterior cover
11: Exterior cover (lid)
20, 30: Circuit unit
40: Vacuum pump unit
PD, PD1-3: Pedestal
HL: Recess
IM: Ion gauge
MF1: Front quadrupole mass filter
CC: Collision cell
MF2: Rear quadrupole mass filter
C: Ion optical axis
FT: Feed-through
CP, CP1: Connector pin
CN, CN1, CN11, CN21: Connector
PL1-PL6: Plate
CA1: First cable
CA11, CA12: Second cable
T1: Terminal (end of first cable)
MT, MT1, MT2, MT01, MT02: Terminal
CA, CA01, CA02: Cable

1. A mass spectrometer comprising:
a chamber forming a vacuum chamber;
an ion optical element arranged along an ion optical axis in the chamber;
a power supply line for supplying power to the ion optical element from a power source arranged outside the chamber; and
a cable connecting the power supply line and the ion optical element,
wherein an opening is formed in at least a portion of wall surfaces of the chamber, excluding upper and lower surfaces, through which the ion optical element can be inserted and removed in and from the chamber and a side lid is provided to cover the opening, and
wherein a connecting position between the power supply line and the cable and a connecting position between the ion optical element and the cable are set at positions that allow the cable to be removed from the opening with the ion optical element housed in the chamber.

2. The mass spectrometer as claimed in claim 1, wherein the power supply line has a separate cable connecting a connector penetrating the wall surface of the chamber and a relay member disposed within the chamber.

3. The mass spectrometer as claimed in claim 2, wherein the relay member is disposed between the ion optical element and the opening.

4. The mass spectrometer as claimed in claim 1, wherein the cable is connected to the ion optical element and the power supply line by a detachable connector.

5. The mass spectrometer as claimed in claim 1, wherein the power supply is disposed adjacent to the chamber outside the chamber, except for a surface side in which the opening is formed.

6. The mass spectrometer as claimed in claim 1, wherein a portion where the power supply line penetrates the wall surface of the chamber is formed at a position other than a surface side where the opening is formed.

7. The mass spectrometer as claimed in claim 1, wherein the ion optical element is a quadrupole mass filter.

8. The mass spectrometer as claimed in claim 1, wherein the mass spectrometer is a mass spectrometer that analyzes a sample supplied from a liquid chromatograph or a gas chromatograph.
